(19) United States
(12) Patent Application Publication
(10) Pub. No.: US 2025/0305899 A1
(43) Pub. Date: Oct. 2, 2025

(54) SIGNAL PROCESSING ASSEMBLY FOR PRESSURE SENSOR AND PRESSURE SENSOR

(71) Applicant: WUHAN FINEMEMS INC., Wuhan (CN)

(72) Inventors: Xiaoping WANG, Wuhan (CN); Dengfeng WU, Wuhan (CN); Fanliang LI, Wuhan (CN); Wan CAO, Wuhan (CN); Bing LI, Wuhan (CN); Tao SHI, Wuhan (CN)

(73) Assignee: WUHAN FINEMEMS INC., Wuhan (CN)

(21) Appl. No.: 19/233,368

(22) Filed: Jun. 10, 2025

Related U.S. Application Data
(63) Continuation of application No. PCT/CN2023/089935, filed on Apr. 21, 2023.

(30) Foreign Application Priority Data
Dec. 13, 2022 (CN) 202211592977.8

(51) Int. Cl. G01L 9/00; G01L 19/14

(52) U.S. Cl. CPC G01L 9/0041; G01L 19/14

(57) ABSTRACT

Disclosed are a signal processing assembly for a pressure sensor and a pressure sensor. The signal processing assembly for the pressure sensor includes a horizontal plate, a first flexible plate, a longitudinal plate, a second flexible plate and a first conductive connecting portion connected in sequence. The horizontal plate, the longitudinal plate and the first conductive connecting portion are provided in sequence from near to far; the first conductive connecting portion is electrically connected to the pressure measurement circuit, and the pressure measurement circuit is provided at a horizontal plane located at a distal side of the first conductive connecting portion, so as to well connect the signal processing circuit and the pressure measurement circuit.

### CROSS-REFERENCE TO RELATED APPLICATIONS

This application is a continuation of International Application No. PCT/CN2023/089935, filed on Apr. 21, 2023, which claims priority to Chinese Patent Application No. 202211592977.8, filed on Dec. 13, 2022. The disclosures of the above-mentioned applications are incorporated herein by reference in their entireties.

### TECHNICAL FIELD

The present application relates to the technical field of sensor technology, and in particular to a signal processing assembly for a pressure sensor and a pressure sensor.

### BACKGROUND

A pressure sensor using a pressure sensitive head introduces a pressure fluid on one side of a metal diaphragm and sets a Wheatstone bridge composed of a strain gauge or a thick film piezoresistor on the other side surface to measure pressure, as shown in Chinese Application Publications CN112857635A and CN115406565A.

In order to reduce the lateral size, one idea of the inventors is to set the circuit boards of these pressure sensors vertically, but because the elastic diaphragm needs to be perpendicular to the pressure joint, when a bonding process is used to connect the measurement circuit and the circuit board, it is difficult to complete the bonding efficiently and accurately even if a specially customized device is used for bonding.

The statements in this section only provide background information related to the present application and may not constitute prior art.

### SUMMARY

The present application provides a signal processing assembly for a pressure sensor and a pressure sensor, which well connects an integrated signal processing circuit with a pressure measurement circuit.

To achieve the above purpose, the present application provides the following technical solutions: a signal processing assembly for a pressure sensor, including: a transverse plate, a first flexible plate, a longitudinal plate, a second flexible plate and a first conductive connecting portion connected in sequence; wherein the transverse plate, the longitudinal plate and the first conductive connecting portion are provided in sequence from near to far; and the first conductive connecting portion is electrically connected to a pressure measuring circuit, and the pressure measuring circuit is provided at a transverse plane located at a distal side of the first conductive connecting portion.

In an embodiment, the signal processing assembly for the pressure sensor is mounted at a mounting seat; the mounting seat extends longitudinally; a side portion of the mounting seat is recessed inward to form an accommodating groove for accommodating the longitudinal plate, and a proximal end and a distal end of the mounting seat are opposite to form a top plate and a semicircular bottom plate; the transverse plate is supported and fixed at a proximal surface of the top plate; and the bottom plate is partially blocked at a proximal end of a pressing cylinder.

In an embodiment, at least one first buckle clamped to the longitudinal plate is provided at each of transverse sides of the accommodating groove.

In an embodiment, a side portion of the bottom plate is provided with a give-way opening extending to the bottom plate for the second flexible plate to pass through; and a proximal side of the bottom plate is provided with a second flexible board arrangement groove laterally communicated to the give-way opening.

In an embodiment, an edge of the top plate is provided with a first flexible board arrangement groove extending longitudinally and communicated to the accommodating groove toward a distal side, and the first flexible board arrangement groove and a give-way opening are located at a same position in a circumferential direction of the mounting seat; and at least two pressure riveting columns are provided at a proximal end of the top plate, and the pressure riveting columns are riveted in corresponding rivet holes opened at the transverse plate toward a proximal side.

In an embodiment, a proximal surface of the transverse plate is provided with a plurality of fourth conductive connecting portions.

In an embodiment, the mounting seat is provided with a second buckle for clamping a metal base.

The present application provides a pressure sensor, including:
a pressure measuring assembly including a pressure tap and a pressure sensitive head, wherein the pressure tap is provided with a pressure channel extending longitudinally, a side of a longitudinal distal end of the pressure sensitive head is recessed inwardly to form a sensing cavity, and a distal end of the sensing cavity is provided with a connecting cylinder; a longitudinal proximal end of the pressure sensitive head is correspondingly formed with an elastic diaphragm, and a pressure measuring circuit is provided at a longitudinal proximal end surface of the elastic diaphragm; and a proximal end of the connecting cylinder is sealedly connected to the pressure tap to cause a proximal end of the pressure channel is in communication with the sensing cavity;
a housing including a cartridge housing extending longitudinally and provided with a distal end sealedly connected to the pressure tap, and an end plate sealing a longitudinal proximal end of the cartridge housing;
a terminal button fixedly connected to an end plate, wherein the terminal button, the housing and the pressure tap are encircled to form a mounting cavity; and
the mounting seat provided in the mounting cavity;
wherein the signal processing assembly for the pressure sensor is provided in the mounting cavity and mounted at the mounting seat, the signal processing assembly for the pressure sensor includes a transverse plate, a first flexible plate, a longitudinal plate, a second flexible plate and a first conductive connecting portion connected in sequence, and the transverse plate, the longitudinal plate and the first conductive connecting portion is provided in sequence from near to far; and the first conductive connecting portion is electrically connected to a pressure measuring circuit, and the pressure measuring circuit is provided at a transverse plane located at a distal side of the first conductive connecting portion.

In an embodiment, the mounting seat extends longitudinally; a side portion of the mounting seat is recessed inward to form an accommodating groove for accommodating the longitudinal plate, and a proximal end and a distal end of the mounting seat are opposite to form a top plate and a semicircular bottom plate; the transverse plate is supported and fixed at a proximal surface of the top plate; and the mounting seat includes a pressing cylinder, and the bottom plate is partially blocked at a proximal end of a pressing cylinder.

In an embodiment, a distal end of the pressing cylinder is pressed against a support step formed at the pressure tap.

In an embodiment, a longitudinal proximal end of the pressure tap extends outward laterally to form a flange, and a proximal end portion of the pressure tap extends outward laterally to form a support connecting ring; the connecting cylinder is sleeved on the flange, and supported and welded on the support connecting ring; and the flange, the support connecting ring and the connecting cylinder are encircled to form a circulation cavity.

In an embodiment, a stress isolation groove is provided between the support step and the support connecting ring.

In an embodiment, at least one first buckle connected to the longitudinal plate is provided at each of lateral sides of the accommodating groove.

In an embodiment, a side of the bottom plate is provided with a give-way opening extending to the bottom plate for the second flexible plate to pass through; and a second flexible board arrangement groove is provided at a proximal side of the bottom plate and is laterally communicated to the give-way opening.

In an embodiment, a disassembling hole extending in a parallel direction to the second flexible board arrangement groove is provided at a side wall of the pressing cylinder, and the disassembling hole extends to a bottom of the accommodating groove.

In an embodiment, an edge of the top plate is provided with a first flexible board arrangement groove extending longitudinally and communicated to the accommodating groove toward the distal end, and the first flexible board arrangement groove and the give-way opening are located at a same position in a circumferential direction of the mounting seat; and at least two pressure riveting columns are provided at a proximal end of the top plate, and the pressure riveting columns are riveted in corresponding rivet holes opened at the transverse plate toward the proximal side.

In an embodiment, the mounting seat is provided with a second buckle for clamping a metal base.

In an embodiment, a second conductive connecting portion is provided at a side portion of the second flexible plate, and the second conductive connecting portion is electrically connected to the metal housing or the pressure tap through a ground pathway embedded in the mounting seat and then grounded; and a third conductive connecting portion is provided at a side portion of the transverse plate, and the third conductive connecting portion is grounded via the metal housing.

In an embodiment, a plurality of fourth conductive connecting portions are provided at a proximal surface of the transverse plate.

In an embodiment, an inner diameter of the proximal end of the pressure channel gradually expands to form a bell mouth.

The signal processing assembly for the pressure sensor of the present application can well connect the integrated signal processing circuit with the pressure measurement circuit.

### BRIEF DESCRIPTION OF THE DRAWINGS

FIG. 1 is a front view of a pressure sensor according to an embodiment of the present application.

FIG. 2 is a cross-sectional view of the pressure sensor according to an embodiment of the present application along the line A-A shown in FIG. 1.

FIG. 3 is a stereoscopic view of the pressure sensor according to an embodiment of the present application (with the housing hidden).

FIG. 4 is a stereoscopic view of a signal processing assembly according to an embodiment of the present application.

FIG. 5 is a stereoscopic view of a mounting seat according to an embodiment of the present application.

FIG. 6 is a stereoscopic view of the mounting seat according to an embodiment of the present application from another perspective.

### DETAILED DESCRIPTION OF THE EMBODIMENTS

The technical solution of the present application will be described clearly and completely below in conjunction with the accompanying drawings. The following embodiments are exemplary and are only used to explain the present application, and cannot be interpreted as limiting the present application. In the following description, the same mark is used to represent the same or equivalent elements, and repeated descriptions are omitted.

In the description of the present application, it should be understood that the orientation or position relationship indicated by the terms “upper”, “lower”, “inner”, “outer”, “left”, “right”, etc. is based on the orientation or position relationship shown in the accompanying drawings, or the orientation or position relationship in which the invention product is usually placed when used, or the orientation or position relationship commonly understood by those skilled in the art, which is only for the convenience of describing the present application and simplifying the description, rather than indicating or implying that the equipment or elements referred to must have a specific orientation, be constructed and operated in a specific orientation, and therefore cannot be understood as limiting the present application.

In addition, the terms “mounted”, “connected”, and “connected” should be understood in a broad sense, for example, it can be a fixed connection, a detachable connection, or an integral connection; it can be a mechanical connection or an electrical connection; it can be directly connected, or indirectly connected through an intermediate medium, or it can be the internal connection of two elements. For ordinary technicians in this field, the specific meanings of the above terms in this application can be understood according to the specific circumstances.

It should also be further understood that the term “and/or” used in the specification of this application and the corresponding claims refers to any combination of one or more of the listed items and all possible combinations.

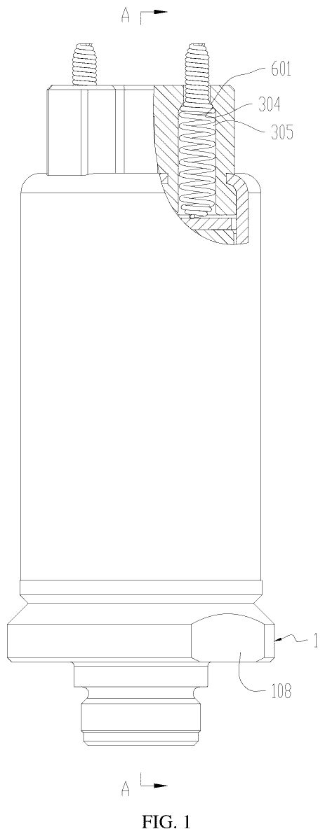

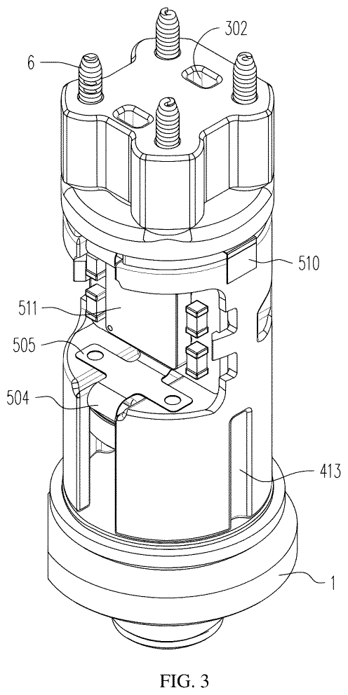

As shown in FIG. 1 to FIG. 3, the pressure sensor of this embodiment uses such a pressure measurement assembly, and the pressure measurement assembly includes a pressure tap 1 and a pressure sensitive head 2. A pressure channel 100 extending longitudinally (i.e., the up and down direction in the drawings) is provided in the pressure tap 1. The longitudinal distal end (i.e., the lower side in the drawings) of the pressure sensitive head 2 is recessed inward to form a distal sensing cavity 203, and a distal end of the distal sensing cavity 203 is provided with a connecting cylinder 202. The longitudinal proximal side of the pressure sensitive head 2 is correspondingly formed with an elastic diaphragm 204. A pressure measurement circuit is provided at the surface of the longitudinal proximal side of the elastic diaphragm 204. The proximal end of the connecting cylinder 202 is sealedly connected to the pressure tap 1 so that the proximal end of the pressure channel 100 is connected to the sensing cavity 203. The distal end of the pressure tap 1 is provided with a connecting pipe 101 connected to the container or pipeline to be measured. The side of the pressure tap 1 may be provided with a concave or straight circumferential positioning portion 108. In an embodiment, the pressure measurement circuit is composed of a thick film varistor.

The proximal end of the connecting cylinder 202 is welded to the pressure tap 1 (for example, laser welding). The pressure measurement assembly of this embodiment is configured to be a split structure of the pressure tap 1 and the pressure sensitive head 2, and is connected as a whole by welding, thereby partially isolating the assembly stress of the pressure tap during installation.

In some other embodiments, the longitudinal proximal end extends outwardly to form a flange 106, and the proximal end of the pressure tap 1 extends outwardly to form a support connecting ring 105. The connecting cylinder 202 is sleeved on the flange 106, and is supported and welded on the support connecting ring 105. The flange 106, the support connecting ring 105 and the connecting cylinder 202 are encircled to form a circulation cavity 107.

In this way, the collapsed welding slag can be collectively accommodated by the annular cavity during welding, thereby avoiding the welding slag blocking the pressure channel.

In order to facilitate the liquid to flow out of the sensing cavity when measuring the pressure of the liquid, the inner diameter of the proximal end of the pressure channel 100 can gradually expand to form a bell mouth 104.

In the above embodiments, the pressure channel 100 can be formed by connecting the small diameter section 102 on the proximal side and the large diameter section 103 on the distal side, so that the pressure fluid can enter the sensing cavity 203.

In an embodiment of the present application, the pressure sensor includes a housing 7, a terminal 3, a mounting seat 4 and a signal processing assembly 5, in addition to the above-mentioned pressure measurement assembly. The housing 7 includes a cartridge housing extending longitudinally and sealedly connected to the distal end to the pressure tap 1, and an end plate 701 that blocks the longitudinal proximal end of the cartridge housing. The end button 3 is fixedly connected to the end plate 701. For example, the longitudinal middle part of the end button 3 may be formed a neck 300, the neck 300 passes through the through hole opened at the end plate 701, and the two are firmly fixed when the end button 3 is injection molded. The terminal 3, the housing 7 and the pressure tap 1 are encircled to form a mounting cavity 400. The mounting seat 4 and the signal processing assembly 5 are both provided in the mounting cavity 400. The signal processing assembly 5 is provided at the mounting seat 4 and electrically connected to the pressure measurement circuit. The signal after the signal processing assembly 5 is output outward through a plurality of electrical connecting members 6, and one end of the electrical connecting member 6 is electrically connected to the signal processing assembly 5 after passing through the end button 3 and the end plate 701 inward. The proximal end of the end button 3 may be provided with a plurality of longitudinally extending first material reduction blind holes 302

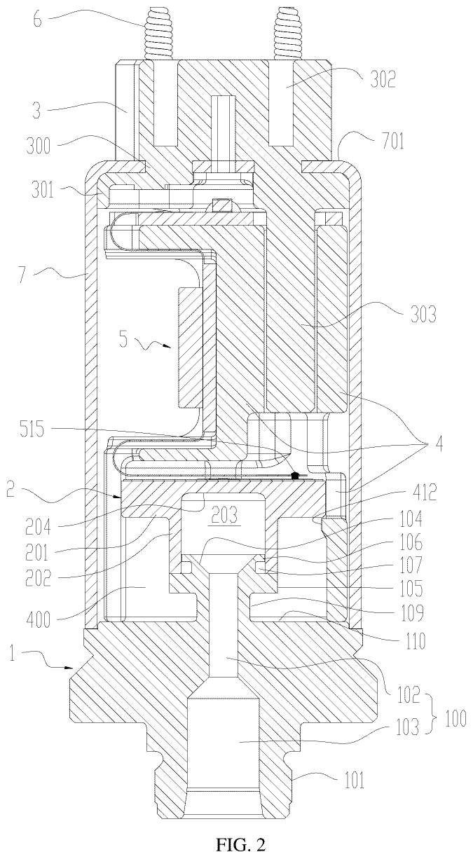

The signal processing assembly 5 may include a transverse plate 502, a first flexible plate 503, a longitudinal plate 501, a second flexible plate 504 and a first conductive connecting portion 506 connected in sequence, and the transverse plate 502, the longitudinal plate 501 and the first conductive connecting portion 506 are provided in sequence from near to far. The first conductive connecting portion 506 and the pressure measurement circuit can be electrically connected by soldering (as shown in the solder joint 515 in FIG. 2). An electronic component 511 (such as a conditioning chip, etc.) may be provided at the longitudinal plate 501. This arrangement can, on the one hand, control the lateral size of the pressure sensor to be very small, so that it can be easily applied to some relatively small spaces (such as some sensor centralized installation modules on cars); at the same time, it can make the measurement circuit that must be provided horizontally be well and conveniently connected to the longitudinal plate 501, thereby avoiding the difficulties in the existing bonding connecting process. These difficulties are manifested in that the two ends of the aluminum wire or gold wire in the bonding process should be parallel and the drop should be controlled within 1 mm, otherwise only specially customized equipment can be used for bonding. Especially when the surfaces of the two connecting points are vertical or even non-parallel, it is difficult to complete the bonding efficiently and accurately even when using specially customized equipment.

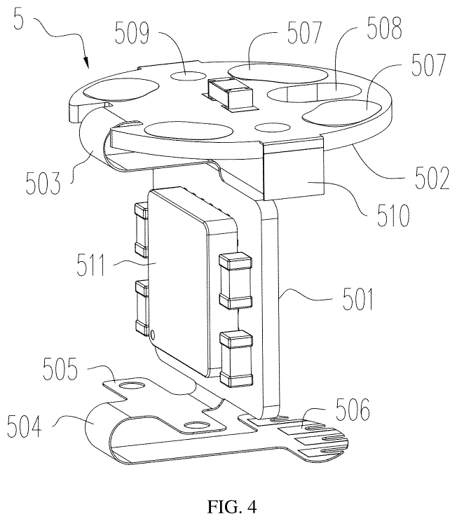

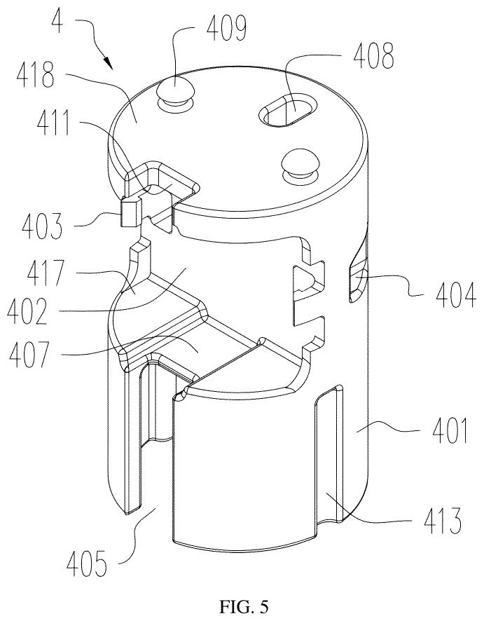

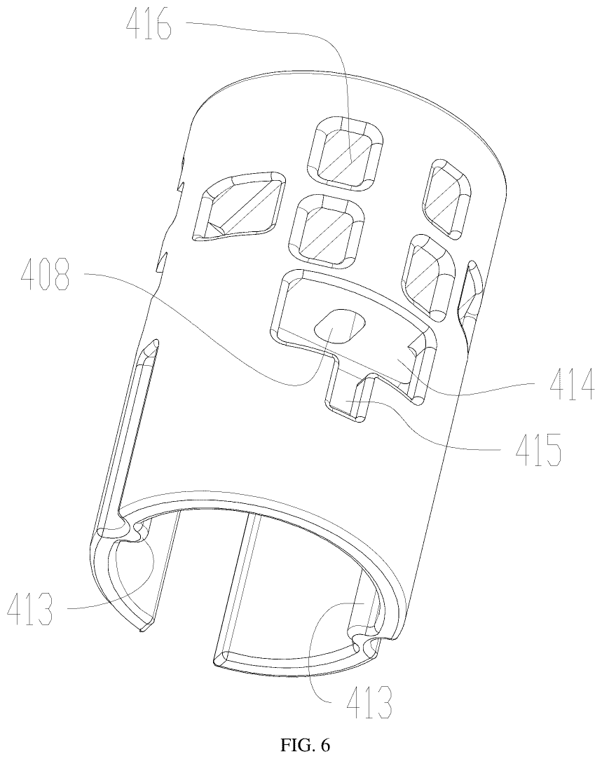

Please refer to FIG. 4 to FIG. 6. In order to reliably install the above-mentioned signal processing assembly 5, the mounting seat 4 extends longitudinally, the side portion of mounting seat 4 is recessed inward to form an accommodating groove 402 for accommodating the longitudinal plate 501, and proximal end and distal end of the mounting seat 4 are relatively formed to form a top plate 418 and a semicircular bottom plate 417. The transverse plate 502 is supported and fixed at the proximal surface of the top plate 418. The bottom plate 417 is partially blocked at the proximal end of a pressing cylinder 401. The distal end of the pressing cylinder 401 is pressed against a support step 110 formed on the pressure tap 1. A stress isolation groove 109 is formed between the support step 110 and the support connecting ring 105 to further isolate the installation stress of the pressure joint 1. At least one first buckle 403 clamped on the longitudinal plate 501 is provided at each of the lateral sides of the accommodating groove 402, thereby avoiding the use of the glue bonding process widely used in the prior art and improving production efficiency. A disassembling hole 404 extending in a parallel direction of the second flexible board arrangement groove 407 can be provided at the side wall of the pressing cylinder 401, and the disassembling hole 404 extends to the bottom of the accommodating groove 402 to facilitate the disassembly of the longitudinal plate 501 in the accommodating groove 402. A give-way opening 405 extending to the bottom plate 417 for the second flexible plate 504 to pass through is provided at the side of the bottom plate 417. A second flexible board arrangement groove 407 that is laterally communicated to the give-way opening 405 is provided at the proximal side of the bottom plate 417. A plurality of second material reducing blind holes 416 may be provided at the side of the mounting seat 4 that faces away from the accommodating groove 402.

A first flexible board arrangement groove 411 that extends longitudinally and is communicated to the accommodating groove 402 toward the distal side is provided at the edge of the top plate 418. The first flexible board arrangement groove 411 and the give-way opening 405 are located at the same position in the circumferential direction of the mounting seat 4. At least two pressure riveting columns 409 are provided at the proximal end of the top plate 418. The pressure riveting columns 409 are riveted in the corresponding rivet holes 509 on the transverse plate 502 toward the proximal side. In some other embodiments, the transverse plate 502 can also be fixed to the mounting seat 4 by other means, for example, a circle of pressing flanges 301 formed by the distal longitudinal protrusion of the end button 3 is clamped on the mounting seat 4 toward the distal end.

A plurality of fourth conductive connecting portions 507 are provided at the proximal surface of the transverse plate 502. The electrical connecting member 6 is an elastic member, such as a conductive spring, and the distal end of the electrical connecting member 6 can be electrically contacted with the fourth conductive connecting portion 507 after being passed through the end button 3 and the end plate 701. In an embodiment, the electrical connecting member 6 is a conductive spring having two sections with different outer diameters of winding, and a conical transition segment 601 is formed between the two sections. A holding cavity 305 for accommodating the electrical connecting member 6 is correspondingly formed on the terminal button 3. The holding cavity 305 has a pressing portion 304, and the pressing portion 304 presses the transition segment 601 toward the distal side against the fourth conductive connecting portion 507.

In some other embodiments, the end button 3 protrudes toward the distal side to form a guide column 303. The guide column 303 is cooperatively inserted into a guide groove 408 provided at the mounting seat 4. An operating port 414 is provided at the side wall of the mounting seat 4 relative to the give-way opening 405 to make room for soldering. The distal edge of the operating port 414 can be recessed toward the distal side to form a notch 415. The inner side wall of the notch 415 protrudes to form a second buckle 412 for clamping the metal base 201. In this way, the mounting seat 4 and the pressure sensitive head 2 can be conveniently fixed. The pressing cylinder 401 can protrude inward or be pressed to form a circumferential positioning guide 413, and the metal base 201 can correspondingly form a guide groove that cooperates with the circumferential positioning guide 413.

In some other embodiments, a third conductive connecting portion 510 is provided at the side of the transverse plate 502. A second conductive connecting portion 505 is provided at the side of the second flexible plate 504. The second conductive connecting portion 505 is electrically connected to the metal housing 7 or the pressure tap 1 through the grounding pathway embedded in the mounting seat 4 and then grounded. The third conductive connecting portion 510 is grounded via the housing 7.

The scope of the present disclosure is not limited by the detailed description, but by the claims and their equivalents, and all variations within the scope of the claims and their equivalents are interpreted as included in the present disclosure.

What is claimed is:

1. A signal processing assembly for a pressure sensor, comprising:
a transverse plate, a first flexible plate, a longitudinal plate, a second flexible plate and a first conductive connecting portion connected in sequence;
wherein the transverse plate, the longitudinal plate and the first conductive connecting portion are provided in sequence from near to far; and
the first conductive connecting portion is electrically connected to a pressure measuring circuit, and the pressure measuring circuit is provided at a transverse plane located at a distal side of the first conductive connecting portion.

2. The signal processing assembly for the pressure sensor according to claim 1, wherein:
the signal processing assembly for the pressure sensor is mounted at a mounting seat;
the mounting seat extends longitudinally;
a side portion of the mounting seat is recessed inward to form an accommodating groove for accommodating the longitudinal plate, and a proximal end and a distal end of the mounting seat are opposite to form a top plate and a semicircular bottom plate;
the transverse plate is supported and fixed at a proximal surface of the top plate; and
the bottom plate is partially blocked at a proximal end of a pressing cylinder.

3. The signal processing assembly for the pressure sensor according to claim 2, wherein at least one first buckle clamped to the longitudinal plate is provided at each of transverse sides of the accommodating groove.

4. The signal processing assembly for the pressure sensor according to claim 2, wherein:
a side portion of the bottom plate is provided with a give-way opening extending to the bottom plate for the second flexible plate to pass through; and
a proximal side of the bottom plate is provided with a second flexible board arrangement groove laterally communicated to the give-way opening.

5. The signal processing assembly for the pressure sensor according to claim 2, wherein:
an edge of the top plate is provided with a first flexible board arrangement groove extending longitudinally and communicated to the accommodating groove toward a distal side, and the first flexible board arrangement groove and a give-way opening are located at a same position in a circumferential direction of the mounting seat; and
at least two pressure riveting columns are provided at a proximal end of the top plate, and the pressure riveting columns are riveted in corresponding rivet holes opened at the transverse plate toward a proximal side.

6. The signal processing assembly for the pressure sensor according to claim 1, wherein a proximal surface of the transverse plate is provided with a plurality of fourth conductive connecting portions.

7. The signal processing assembly for the pressure sensor according to claim 2, wherein the mounting seat is provided with a second buckle for clamping a metal base.

8. A pressure sensor, comprising:
a pressure measuring assembly comprising a pressure tap and a pressure sensitive head, wherein the pressure tap is provided with a pressure channel extending longitudinally, a side of a longitudinal distal end of the pressure sensitive head is recessed inwardly to form a sensing cavity and a distal end of the sensing cavity is provided with a connecting cylinder; a longitudinal proximal end of the pressure sensitive head is correspondingly formed with an elastic diaphragm, and a pressure measuring circuit is provided at a longitudinal proximal end surface of the elastic diaphragm; and a proximal end of the connecting cylinder is sealedly connected to the pressure tap to cause a proximal end of the pressure channel is in communication with the sensing cavity;
a housing comprising a cartridge housing extending longitudinally and provided with a distal end sealedly connected to the pressure tap, and an end plate sealing a longitudinal proximal end of the cartridge housing;
a terminal button fixedly connected to an end plate, wherein the terminal button, the housing and the pressure tap are encircled to form a mounting cavity; and
the mounting seat provided in the mounting cavity;
wherein the signal processing assembly for the pressure sensor is provided in the mounting cavity and mounted at the mounting seat, the signal processing assembly for the pressure sensor comprises a transverse plate, a first flexible plate, a longitudinal plate, a second flexible plate and a first conductive connecting portion connected in sequence, and the transverse plate, the longitudinal plate and the first conductive connecting portion is provided in sequence from near to far; and
the first conductive connecting portion is electrically connected to a pressure measuring circuit, and the pressure measuring circuit is provided at a transverse plane located at a distal side of the first conductive connecting portion.

9. The pressure sensor according to claim 8, wherein:
the mounting seat extends longitudinally;
a side portion of the mounting seat is recessed inward to form an accommodating groove for accommodating the longitudinal plate, and a proximal end and a distal end of the mounting seat are opposite to form a top plate and a semicircular bottom plate;
the transverse plate is supported and fixed at a proximal surface of the top plate; and
the mounting seat comprises a pressing cylinder, and the bottom plate is partially blocked at a proximal end of a pressing cylinder.

10. The pressure sensor according to claim 9, wherein a distal end of the pressing cylinder is pressed against a support step formed at the pressure tap.

11. The pressure sensor according to claim 10, wherein:
a longitudinal proximal end of the pressure tap extends outward laterally to form a flange, and a proximal end portion of the pressure tap extends outward laterally to form a support connecting ring;
the connecting cylinder is sleeved on the flange, and supported and welded on the support connecting ring; and
the flange, the support connecting ring and the connecting cylinder are encircled to form a circulation cavity.

12. The pressure sensor according to claim 11, wherein a stress isolation groove is provided between the support step and the support connecting ring.

13. The pressure sensor according to claim 9, wherein at least one first buckle connected to the longitudinal plate is provided at each of lateral sides of the accommodating groove.

14. The pressure sensor according to claim 9, wherein a side of the bottom plate is provided with a give-way opening extending to the bottom plate for the second flexible plate to pass through; and
a second flexible board arrangement groove is provided at a proximal side of the bottom plate and is laterally communicated to the give-way opening.

15. The pressure sensor according to claim 14, wherein a disassembling hole extending in a parallel direction to the second flexible board arrangement groove is provided at a side wall of the pressing cylinder, and the disassembling hole extends to a bottom of the accommodating groove.

16. The pressure sensor according to claim 9, wherein an edge of the top plate is provided with a first flexible board arrangement groove extending longitudinally and communicated to the accommodating groove toward the distal end, and the first flexible board arrangement groove and the give-way opening are located at a same position in a circumferential direction of the mounting seat; and
at least two pressure riveting columns are provided at a proximal end of the top plate, and the pressure riveting columns are riveted in corresponding rivet holes opened at the transverse plate toward the proximal side.

17. The pressure sensor according to claim 9, wherein the mounting seat is provided with a second buckle for clamping a metal base.

18. The pressure sensor according to claim 9, wherein:
a second conductive connecting portion is provided at a side portion of the second flexible plate, and the second conductive connecting portion is electrically connected to the metal housing or the pressure tap through a ground pathway embedded in the mounting seat and then grounded; and
a third conductive connecting portion is provided at a side portion of the transverse plate, and the third conductive connecting portion is grounded via the metal housing.

19. The pressure sensor according to claim 8, wherein a plurality of fourth conductive connecting portions are provided at a proximal surface of the transverse plate.

20. The pressure sensor according to claim 8, wherein an inner diameter of the proximal end of the pressure channel gradually expands to form a bell mouth.
